(19) United States
(12) Patent Application Publication
(10) Pub. No.: US 2007/0292826 A1
(43) Pub. Date: Dec. 20, 2007

(54) SYSTEM AND METHOD FOR MATCHING READERS WITH BOOKS

(75) Inventors: David Goddy, Brooklyn, NY (US); Sarah Montante, Cambridge, MA (US)

Correspondence Address: DICKSTEIN SHAPIRO LLP, 1177 AVENUE OF THE AMERICAS (6TH AVENUE), NEW YORK, NY, 10036-2714, US

(73) Assignee: Scholastic Inc.

(21) Appl. No.: 11/750,677

(22) Filed: May 18, 2007

Related U.S. Application Data
(60) Provisional application No. 60/747,550, filed on May 18, 2006.

(51) Int. Cl. G09B 19/00

(52) U.S. Cl. 434/156

(57) ABSTRACT

The system and methods of the present application comprise one or more computers that determine the reading level of a reader and recommend books to the reader. Information and computer software stored and executed on a general purpose computer provide a user with the ability to determine the reader's capacity to read and comprehend, and recommends books that are within the reader's capacity. The system and methods also determine subject matter that the reader seeks, and recommends books associated with the subject matters sought.

### FIELD OF THE INVENTION

The present invention relates generally to the field of automated book recommendation and more particularly, a system and process for determining the reading level of a person in order to make a book recommendation commensurate with the reading level, and optionally, preferences, of the reader.

### BACKGROUND OF THE INVENTION

A number of search engines are currently available on the Internet, accessible via the World Wide Web, to help people find books. In addition, there are a number of Internet vending sites, such as Amazon.com ™ or Barnesandnoble.com ™, that provide users with the ability to browse and purchase books online. Many of these sites provide the ability to search for and select particular books, for example, by supplying keywords that are present in the title or description of the book. Sites that do not supply such search capability, but make their Web pages available, can be periodically crawled by standard search engines that can be utilized for the same type of keyword searches.

Some more general vending Web sites allow the customer to specify a particular category of products such as books, for example, that are appropriate to a particular age group, are in a particular price range, have a particular genre, or come from a particular publisher. A customer can then select and purchase a book, for example, by providing a credit card number to charge for the book, and an address to ship the book.

However, these Web sites do not ensure that the books retrieved during such searches are appropriate for the reader in general, and in particular the reader's reading level.

### BRIEF SUMMARY OF THE INVENTION

The system and methods of the present application comprise one or more computers that determine the reading level of a reader and recommend books to the reader based, at least in part, on the determined reading level. Information and computer software stored and executed on a general purpose computer provide a user with the ability to determine the reader's capacity to read and comprehend, and recommends books that are within the reader's capacity. The system and methods also determine subject matter that the reader seeks, and recommends books associated with the subject matters sought.

In one aspect, the present invention is directed to a method of determining a reading level of a reader, comprising: presenting a passage correlated with an estimated reading level; soliciting feedback that indicates relative ability of the reader to read the passage; and determining reading level of the reader from the feedback.

In another aspect of the present invention, the method further comprises determining the estimated reading level from information about the reader.

In another aspect of the present invention, the information comprises age.

In another aspect of the present invention, the information comprises grade level.

In another aspect of the present invention, the reading level comprises a lexile measure.

In another aspect of the present invention, the method further comprises: presenting one or more additional passages in response to the feedback, each of the presented passages having a different estimated reading level; receiving further feedback that indicates a particular passage is commensurate with reading ability of the reader; and setting the reading level of the reader at reading level associated with the particular passage.

In another aspect, the present invention is directed to a method of recommending a book to a reader, comprising: presenting a passage correlated with an estimated reading level; soliciting feedback that indicates relative ability of the reader to read the passage; determining reading level of the reader from the feedback; and recommending one or more books associated with the determined reading level.

In another aspect of the present invention, the method further comprises: receiving information concerning subject matter classification.

In another aspect of the present invention, recommending further comprises selecting books associated with the information received concerning subject matter classification.

In yet another aspect, the present invention is directed to a computer system to determine a reading level of a reader, comprising: a processor; a memory; a display; a user interface; and software stored on a computer-readable medium which, when loaded and run by the processor, causes the processor to perform steps of: presenting a passage correlated with an estimated reading level of the reader; soliciting feedback that indicates relative ability of the reader to read the passage; and determining reading level of the reader from the feedback.

In another aspect of the present invention, the software causes the processor to perform additional steps of: soliciting age or grade level information about the reader; determining the estimated reading level of the reader from the information; and selecting the passage having a reading level around the estimated reading level.

In another aspect of the present invention, the software causes the processor to perform additional steps of: presenting one or more additional passages in response to the feedback; receiving feedback that indicates a particular passage is commensurate with reading ability of the reader; and setting the reading level of the reader at reading level of the particular passage.

In another aspect of the present invention, the software causes the processor to perform an additional step of recommending one or more books associated with the determined reading level.

### BRIEF DESCRIPTION OF THE DRAWINGS

FIG. 1 is a block diagram that illustrates an computer architecture of a preferred embodiment of the present invention;

FIG. 2 is a block diagram that illustrates the interrelationship between data stored on a server computer;

FIG. 3 is a diagram illustrating a database schema of some of the tables in relational database;

FIG. 4 is a flow chart that illustrates a preferred method for recommending books;

FIGS. 5 and 6 are screen diagrams illustrating sample text presentation in a preferred embodiment of the present invention;

FIGS. 7 and 8 are screen diagrams illustrating selecting subject matter of interest to a reader in a preferred embodiment;

FIG. 9 is a screen diagram that represents book recommendations presented to the user; and

FIG. 10 illustrates examples of computer-readable media.

### DETAILED DESCRIPTION OF THE INVENTION

It is well known that children learn to read at a variety of ages. In general, there is no cause for concern if a child is not yet reading independently by a certain age. Educators call children who are not yet reading independently emergent readers, because before they are reading on their own, they are starting to develop skills and dispositions that will make them successful readers later.

Appropriate books for emergent readers include books with repetitive text, chants, and rhymes, because a child can begin to contribute as books are read aloud with an adult. Emergent readers can often predict what the next word or phrase might be, and will begin to associate the text with the predicted word. Picture books with minimal text on each page also helps the child to follow along with the story as an adult reads. Non-fiction picture books also may describe a fascinating world around the emergent reader, and there are many outstanding, simple concept books for emergent readers.

The present invention comprises a system and methods for determining reading level of a reader and appropriate books for readers in general, and emergent and semi-proficient readers in particular. The system comprises one or more computers that interact with a user in order to determine the reading ability of the reader, and proposes books at the appropriate reading level that match the tastes of the reader.

The present invention may be described herein in terms of functional block components, code listings, optional selections and various processing steps. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices.

Similarly, the software elements of the present invention may be implemented with any programming or scripting language such as C, C++, C#, Java, COBOL, assembler, PERL, Visual Basic, Python, CGI, PHP or the like, with the various algorithms being implemented with any combination of data structures, objects, processes, routines or other programming elements. The object code created for the computers can preferably be executed by any general purpose computer such as a personal computer having an appropriate operating system such as Windows ™ or MAC™ and an appropriate browser such as Internet Explorer,™ Netscape™ or Safari.™

Further, it should be noted that the present invention may employ any number of conventional techniques for data transmission, signaling, data processing, network control, and the like.

It should be appreciated that the particular implementations shown and described herein are illustrative of the invention and its best mode and are not intended to otherwise limit the scope of the present invention in any way. Indeed, for the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical or virtual couplings between the various elements. It should be noted that many alternative or additional functional relationships or physical or virtual connections may be present in a practical electronic data communications system.

As will be appreciated by one of ordinary skill in the art, the present invention may be embodied as a method, a data processing system, a device for data processing, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The present invention is described below with reference to block diagrams and flowchart illustrations of methods, apparatus (e.g., systems), and computer program products according to various aspects of the invention. It will be understood that each functional block of the block diagrams and the flowchart illustrations, and combinations of functional blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems that perform the specified functions or steps, or suitable combinations of special purpose hardware and computer instructions.

One skilled in the art will also appreciate that, for security reasons, any databases, systems, or components of the present invention may consist of any combination of databases or components at a single location or at multiple locations, wherein each database or system includes any of various suitable security features, such as firewalls, access codes, encryption, de-encryption, compression, decompression, and/or the like.

The scope of the invention should be determined by the appended claims and their legal equivalents, rather than by the examples given herein. For example, the steps recited in any method claims may be executed in any order and are not limited to the order presented in the claims. Moreover, no element is essential to the practice of the invention unless specifically described herein as “critical” or “essential.”

System Architecture

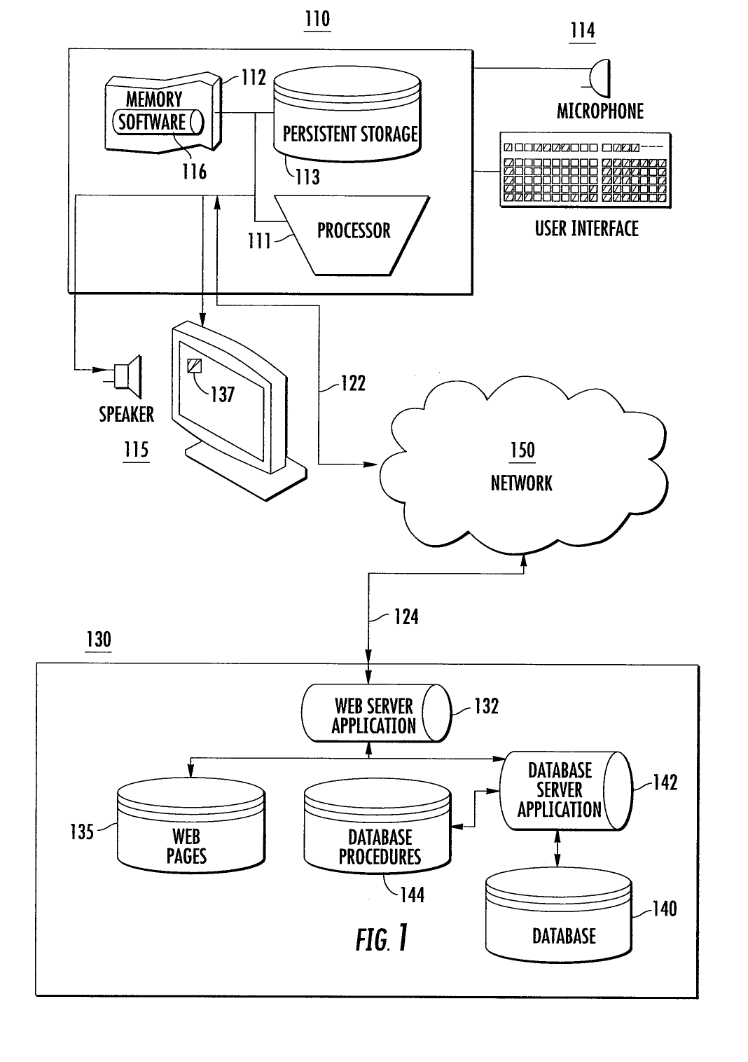

FIG. 1 is a block diagram that illustrates an computer architecture of a preferred embodiment of the present invention. In a preferred embodiment, the system and method of the present invention are directed to a computer in communication with a server through the Internet. Referring to FIG. 1, one or more client computers 110 and a server computer 130 are coupled over communication links 122, 124, respectively to network 150. Network 150 may comprise, for example, the Internet, a wide area network (WAN), or a local area network (LAN). Together, software that executes on a client computer 110 and on server computer 130 forms a client/server software system.

Client computer 110 comprises a processor 111, memory 112, user interface 114 and a display 115. Memory 112 may also include persistent storage 113. In a preferred embodiment, software on client computer 110 comprises a Web browser 116, such as Internet Explorer,™ Netscape,™ Firefox,™ Safari™ or other Web browser pre-loaded into memory 112 of client computer 110 or readily-available for download from the Internet into memory 112. Such browsers retrieve Web pages 135 from a Web server 130 in response to inputs on user interface 114. Web pages 135 are loaded into memory 112 and then rendered on display 115.

User interface 114 comprises controls that are preferably graphically represented buttons 137, with symbols commonly found in many Web pages to permit entry of information or selection of actions. User interface 114 may be a keyboard, mouse or other pointing device, or other information or control input device that affects the operation of client computer 110, as is well known in the art. User interface 114 may also comprise a microphone that provides the user with a means to convey digitized audio information.

Display 115 comprises a CRT (cathode ray tube) or LCD (liquid crystal display), or other visual display device as is commonly known in the art. Display 115 may further comprise speakers that receive digitized audio signals and emit audio output audible to the user. As is well known in the art, speakers may also be in a headset that comprises a microphone.

Software on server computer 130 preferably comprises a Web server application 132. Web server application 132 listens for TCP/IP (transport control protocol/Internet protocol) connections on a well-known port and receives standard HTTP (hyper-text transfer protocol) requests on that port that identifies particular UTRL (universal resource locator) that indicates Web pages 135 and other information requested, typically by Web browser 116 on client computer 110. Preferably, Web server application 132 comprises Apache and a collection of software modules that generate HTML (hyper-text markup language) Web pages 135. In alternate embodiments, the functions performed by server computer 130 are split among several server computers, for example, having components of Web server application 132 executed on computers different from database server application 142 (described below). Furthermore, these servers may be geographically separated and, for example, coupled through network 150.

In addition, server computer 130 includes a database 140 that includes information related to people and books. A database server application 142 is coupled to database 140 and provides an interface to the information stored in database 140 to other application software modules that execute on server computer 130. In a preferred embodiment, database 140 is a relational database, which includes a number of interrelated tables. Database server application 142 is preferably an SQL (structured query language) server that accepts queries according to an SQL syntax and provides responses to those queries. Database server application 142 can perform stored database procedures 144 comprising complex queries stored in SQL syntax on server computer 130. Such queries may involve multiple fetching processes from more than one table in the tables that comprise database 140. Stored database procedures 144 are stored in a file system on server computer 130.

Although FIG. 1 illustrates only one server computer 130 and one client computer 110 in communication through network 150, it should be understood that different numbers of computers may be utilized. In one example, the claimed method and system may comprise a single, stand-alone computer, in which case the network would comprise the internal data communication bus of such computer. In another example, the network 150 may include a plurality of network computers and tens or hundreds of computers, all of which may be interconnected via the network 150. In a preferred embodiment, a plurality of client computers 110 are able to simultaneously connect to the server 130. The communication links 122, 124 may be provided as a dedicated hardwired link or a wireless link. Although the communication links 122, 124 are shown as a single data link, they may comprise multiple data links.

The networked computers, client computer 110 and server computer 130, may be provided in many different geographic locations including a school classroom, library, home, different areas of the same city, or they may be located in different states or even countries. Network 150 may include a plurality of network computers or server computers (not shown), each of which may be operatively interconnected. Where the network 150 comprises the Internet, data communication may take place over communication links via an Internet communication protocol (UDP/IP or TCP/IP). Where the network 150 comprises a wireless network, data communication may take place over communication links via a wireless data protocol such as CDMA2000 or W-CDMA. Similarly, where the network communications comprise data, voice and video, communication may take place via an Internet communication protocol or a wireless protocol.

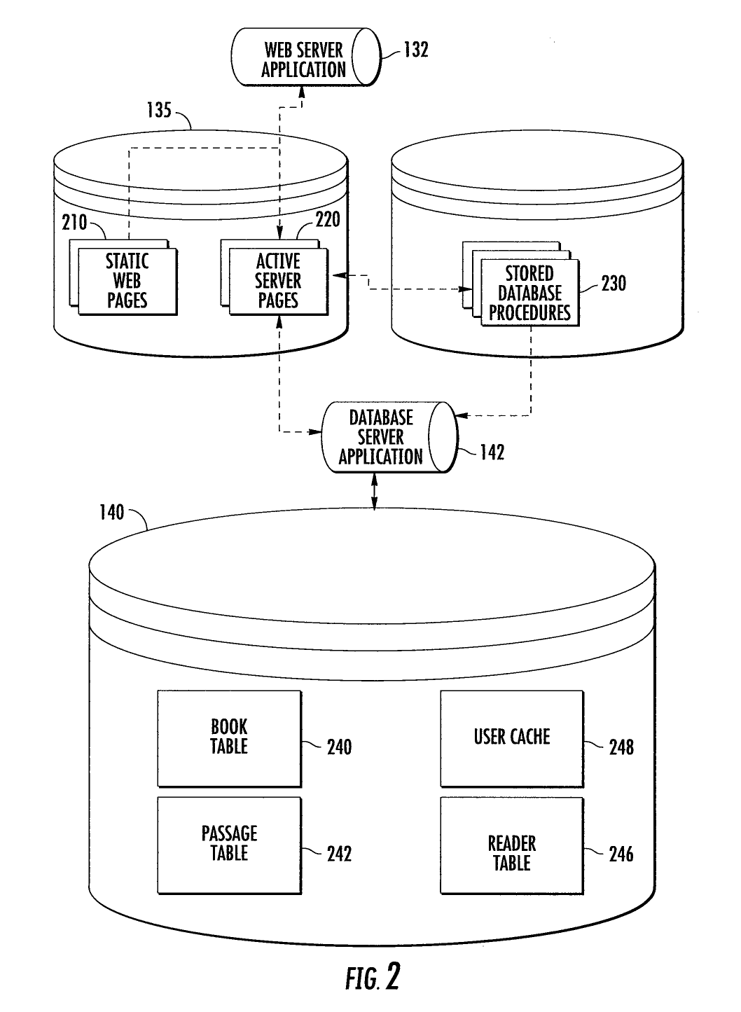

FIG. 2 is a block diagram that illustrates the interrelationship between data stored on a server computer. Referring to FIG. 2, Web pages 135 comprise at least two types of pages. One type are static Web pages 210, that are HTML format pages passed on by Web server application 132 direct to a requesting Web browser without modification. The other type are dynamic or active server pages 220. An active server page 220 includes a procedure specification that, when requested by a Web browser, is executed under the control of Web server application 132 rather than being directly passed to the Web browser. Execution of the procedure specified by an active server page 220 produces HTML formatted information that is passed by Web server application 132 to a Web browser. In a preferred embodiment, active server pages 220 can be generated by a Visual Basic language procedure, CGI scripts, or a procedure written in some other programming or scripting language such as java, perl, python or php, that are executed under the control of Web server application 132.

Active server pages 220 can include references to services provide by database server application 142. For instance, a Visual Basic procedure in active server page 220 accesses database server application 142 through an API (application program interface) for the database server application. During execution of the stored procedure, Web server application 132 can access data stored in database 140. Active server pages 220 can also include references to stored database procedures 230. Each stored database procedure 230 includes one or more SQL statements. Web server application 132 invokes a stored database procedure 230 during execution of an active server page 220. Database server application 142 controls the execution of stored database procedure 230 to provide data to Web server application 132. Together, static Web pages 210, active server pages 220, and stored database procedures 230 provide the information to generate Web pages through which a user interacts with the system.

Database 140 includes a number of separate tables. A book table 240 includes information related to a categorization of books. Like all tables in a database, book table 240 is dynamic in that it can be modified, for example, as new books are added or as characteristics of existing books are modified or refined. A passage table 242 is used to associate a passage of text with particular reading skills in a mapping between text and reading skills. Together with book table 240, passage table 242 provides data needed to recommend books based on the relationships to a desired or possessed set of reading skills, as further explained below.

Database 140 also includes a reader table 246 that includes information about users in general, and about a particular reader, that is persistent between sessions where a user interacts with the server computer. Information about a reader may include their name, as well as other characteristics about the reader, such as sex, date of birth/age, school grade level, reading ability or skill, interests, and subjects of books that the reader prefers. Interests might include, for example, subjects such as pets, nature, celebrities, dance, sports, arts and crafts, games, astronomy, geology, adventures or geography. Types of books might comprise fictional but realistic stories about children like themselves, fantasy stories, fairy tales, or non-fiction, such as historical accounts, presentations of fact or figures, or activity books that teach the reader how to perform tasks.

Database 140 also includes a user cache 248, that is used to store intermediate results while the system interacts with a user during a session. User cache 248 is used to avoid computing results again during a current session and improves the user's experience during the session. Information in user cache 248 has a limited lifetime. For example, data in user cache 248 is periodically removed if it has not been accessed for a predetermined amount of time.

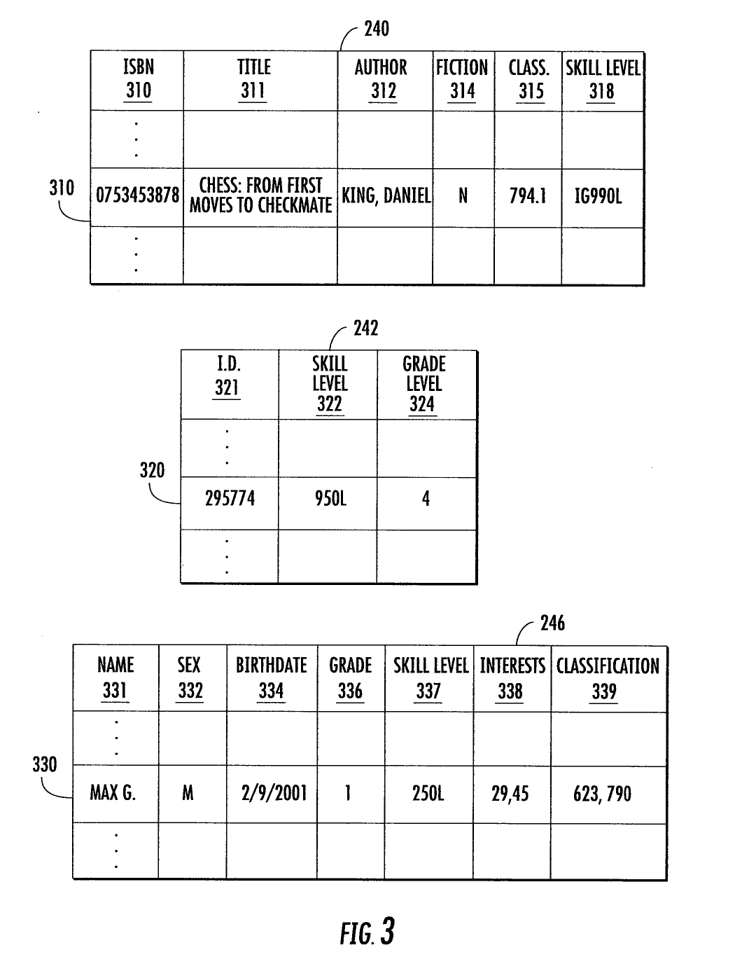

FIG. 3 is a diagram illustrating a database schema of some of the tables in relational database 140. Referring to FIG. 3, database 140 includes a book table 240 that relates books to reading skill level, a passage table 242 that relates a sample passage to reading skill level, and a reader table 246 that relates personal indicia to reading skill level.

As illustrated in FIG. 3, book table 240 comprises the following fields: International Standards Book Number (ISBN) 311, title 312, author 313, fiction flag 314, classification 315 and skill level 318. Many other fields may be included in the book table that describe characteristics of the book, such as publisher, copyright date, etc. ISBN field 311 uniquely identifies the particular book in the table. See http://www.isbn.org/standards/home/isbn/us/isbnqa.asp#Q1, incorporated by reference herein. Fiction flag 314 is a boolean value that indicates whether the book is a work of fiction or not. Classification 315 may be a categorization of the subject matter to which the book relates. One well-known subject matter classification scheme is the Dewey decimal system. See http://en.wikipedia.org/wiki/Dewey Decimal Classification, incorporated by reference herein. Other subject matter classification schemes may be incorporated in separate fields, such as the type of book, keywords, or interests that the book relates to, as mentioned above. Skill level 318 indicates the relative difficulty the book presents to a reader. A preferred measure of skill level is lexile. The lexile measure of a book refers to its text difficulty. Lexile measures are based on two well-established predictors of how difficult a text is to comprehend: word frequency and sentence length. See
http://www.lexile.com/DesktopDefault.aspx?view=ed&tabindex=5&tabid=67, incorporated by reference herein. Other skill measures may be incorporated, such as the Automated Readability Index (ARI) or Fleisch-Kincaid Grade Level. See
http://en.wikipedia.org/wiki/Automated Readability Index and
http://en.wikipedia.org/wiki/Flesch-Kincaid, both of which incorporated by reference herein.

Illustrated in FIG. 3 is an exemplary row 310 for book table 240 populated with data. Data in exemplary row 310 is for a book titled, “Chess: From First Moves to Checkmate,” written by Daniel King and having the ISBN 0753453878. This non-fictional book has a lexile of IG990L, and is classified under the Dewey Decimal System as 794.1.

Passage table 242, illustrated in FIG. 3, comprises fields ID. 321, skill level 322, and grade level 324. ID 321 represents an identifier for a passage of sample text. Sample text (not illustrated) may be a few sentences, a paragraph, or several paragraphs, but is preferably relatively short. Sample text has been previously analyzed and was assigned a particular skill level 322. In a preferred embodiment, skill level is a lexile measure. Grade level 324 corresponds to the number of years of education that a reader is generally required to have in order to understand this text. Grade level 324 denotes the number of years of education that a reader will most likely have in a U.S. public education system.

An exemplary row 320 for passage table 242 is illustrated in FIG. 3. Data in exemplary row 320 is for a passage identifier 295774. The associated sample text has a lexile of 950L and should be used to test 4th grade readers.

Reader table 246, illustrated in FIG. 3, comprises the fields name 331, sex 332, birthdate 334, grade 336, skill level 337, interests 338 and classification 339. Name 331 comprises the name of the reader (not necessarily the user of the computer system). Sex 332 is a boolean flag denoting whether the reader is male or female. Birthdate 334 is the reader's date of birth. Grade 336 denotes the number of years of education that the reader has. Typically, grade can be correlated with birthdate 334, but there are no universal standards that require all persons must enter school at a given time. Everyone has different abilities, and some people might have moved up or down in grade level. Skill level 337 is preferably the predicted lexile of the reader, but it may be the actual lexile, as discussed further below. Interests 338 comprise a list of codes that correspond with the reader's interests in reading materials, as explained earlier. Classification 339 comprises a list of codes relating to subjects that the reader prefers. The subject matter codes in the Classification field 339 are preferably in the Dewey Decimal System, as explained above.

An exemplary row 330 for Reader table 246 is illustrated in FIG. 3. Data in exemplary row 330 is for a reader named Max G., a boy born on Feb. 9, 2001. He is in the first grade and has a lexile of 250L. He has interests corresponding to codes 29 and 45, and likes books pertaining to subject matter codes 623 and 790.

System Operation

The following discussion describes the methods performed by the inventive system. To provide context, the operation of an exemplary, preferred embodiment of web server application 132 and database server application 142 are described. The description is based on that actions that the computers will perform when the applications are loaded and run.

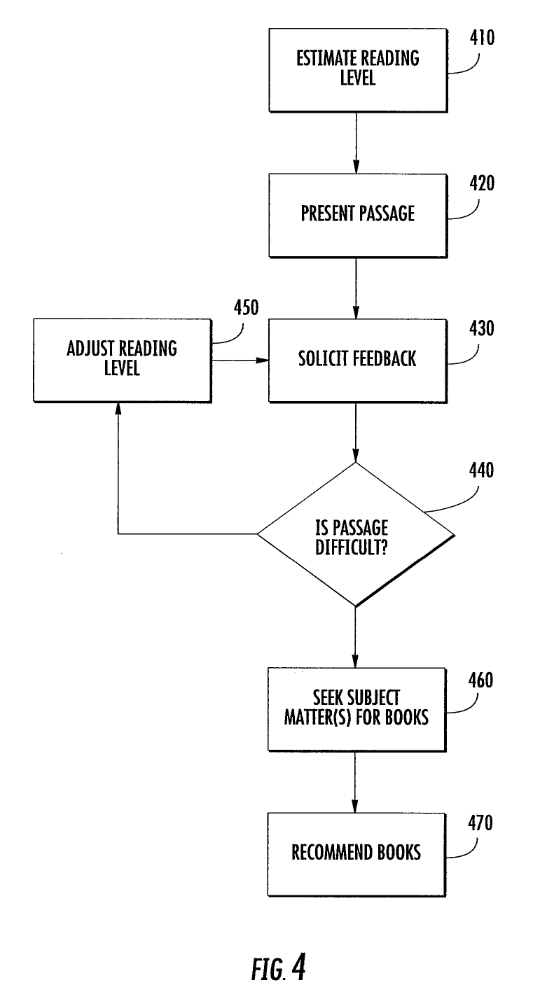

FIG. 4 is a flow chart that illustrates a preferred method for recommending books. In step 410, illustrated in FIG. 4, the reader's approximate reading level is estimated. The system solicits basic information about the reader, such as name, birthdate and grade level, and records this information in reader table 246. The system estimates the reader's reading level from the reader's age, or even more precisely from the reader's grade level. In theory, a user looking for books might know the reader's reading level from test scores provided by the reader's educational institution, or from an online test, in which case the reader's estimated reading level could be directly entered. In this circumstance, the reader's reading level could be checked by the inventive method.

In step 420, a passage is selected that most nearly matches the reader's estimated reading level. The passage is selected via query to passage table 244, the sample text is retrieved, and presented to the reader for viewing. As further explained below, three passages are preferably retrieved from passage table 244 and presented to the user. The passage most closely corresponding to the reader's skill level is retrieved and presented, as well as a passage one or more levels below the reader's skill level and a passage one or more levels above the reader's skill level. As explained above, one of the target groups of readers for the present invention is the young beginning readers. For this target group, it is envisioned that the user being presented the various passages for viewing and selection is a parent, sibling, teacher or other party that knows the ability of the particular reader and make a determination as to whether a passage of a particular reading difficulty is appropriate for the particular reader.

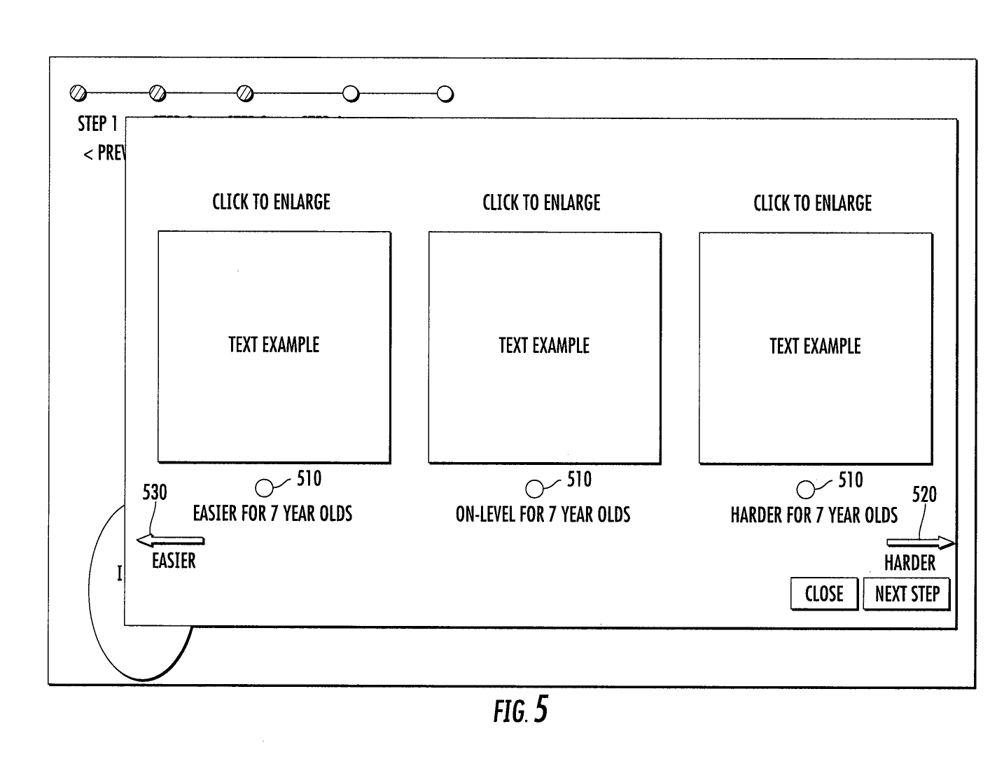

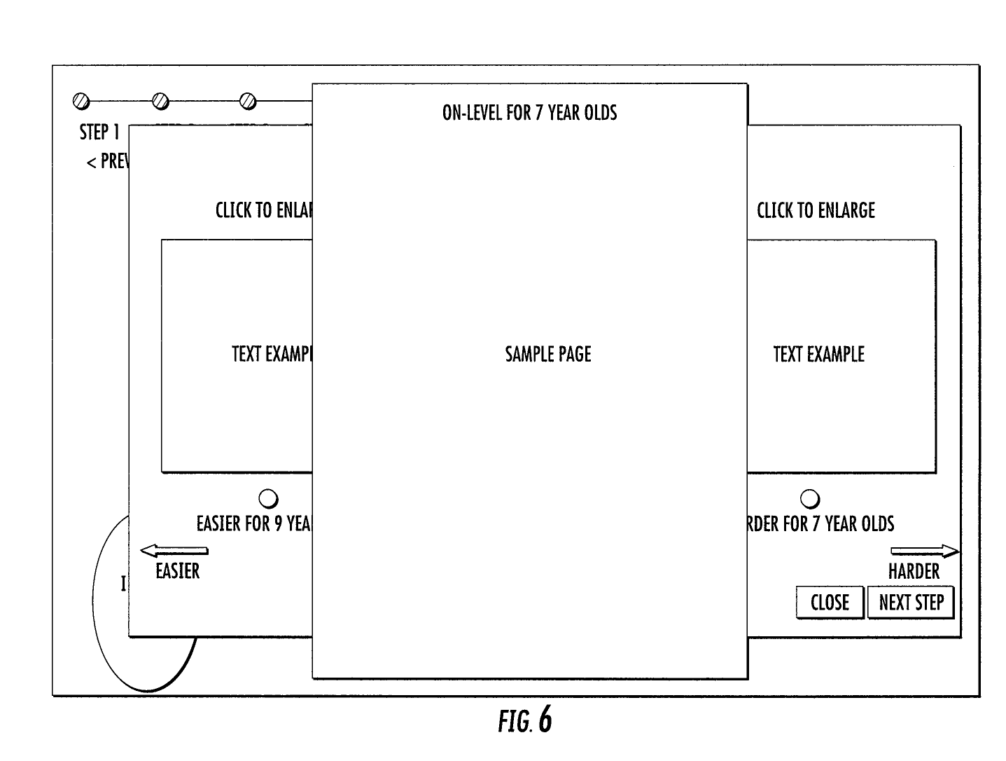

FIGS. 5 and 6 are screen diagrams illustrating sample text presentation in a preferred embodiment of the present invention. As shown in FIG. 5, three sample texts (text examples) are provided for a seven (7) year old reader. The three sample text passages represent three different reading levels for a reader that is seven years old. As illustrated in FIG. 5, the text on the left represents a passage at a reading level that is anticipated to be easier for seven year olds. The center sample text represents a passage of a reading skill level that is at the expected reading level for seven year olds. The right sample text represents a passage at a reading level that is harder for seven year olds to read.

When the user clicks on a sample text, the text is enlarged and overlayed on the screen, as illustrated in FIG. 6. As shown in FIG. 6, the user clicked the center text sample, which is now prominently displayed. Clicking again will close the window.

Returning to FIG. 4, in step 430, the system solicits feedback concerning the displayed passage. In a preferred embodiment illustrated in FIG. 5, the user may choose which sample text best represents the reading level of the reader, by selecting the circular dialog buttons 510 below each sample. In a preferred embodiment, if the feedback indicates that presented passage is above the reader's relative ability to read the presented passage, the system presents an additional passage with a lower estimated reading level. If the feedback indicates that presented passage is below the reader's relative ability to read the presented passage, then the system presents an additional passage with a higher estimated reading level.

In step 440 of FIG. 4, the system determines if the passage is at an appropriate reading skill level for the reader. In a preferred embodiment, this determination is made, as illustrated in FIG. 5, by the user selecting a passage and then clicking the next step button. The inventive method then continues with step 460, described below. If even the harder passage is still too easy for the reader, the user may click the harder arrow 520 in the lower right hand corner of the screen illustrated in FIG. 5. This action will cause the system to retrieve the next harder text passage from the passage database 242, and again display to the user, three different passages of three different difficulties. Similarly, if the easier passage that is currently being displayed is too hard for the reader, the user may click the easier arrow 530 and cause the system to display an easier text passage that can be selected by the user.

In step 450, the estimated reading level of the reader is adjusted up or down in response to the determination made in step 440. The process then continues with step 420, described above.

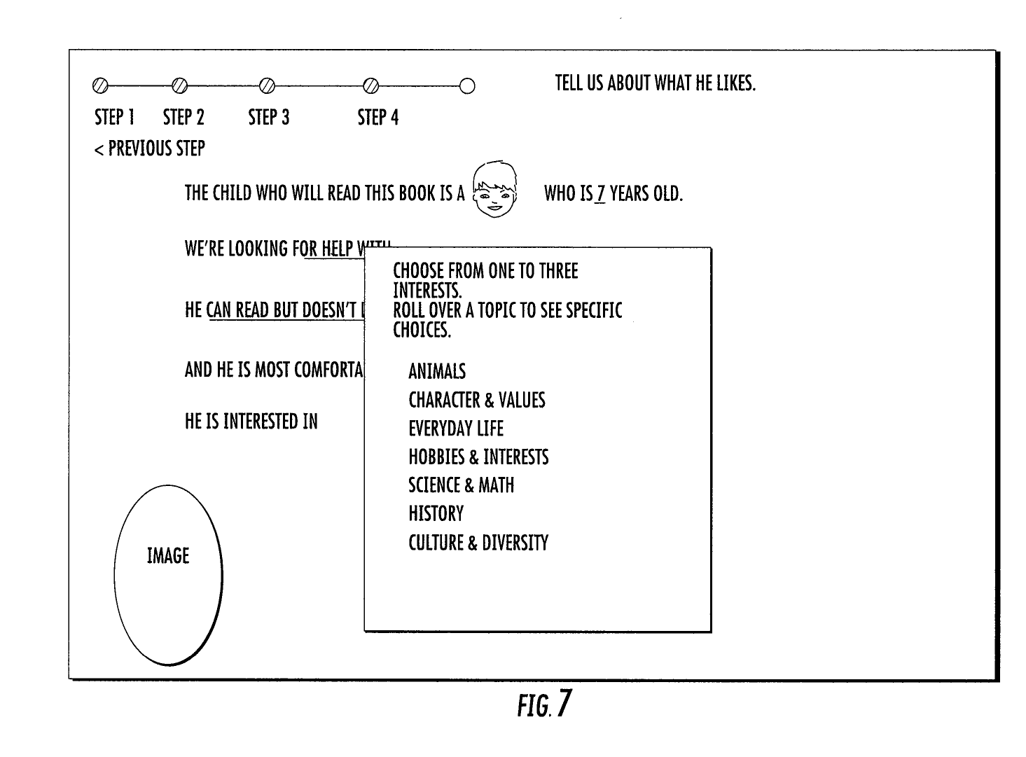

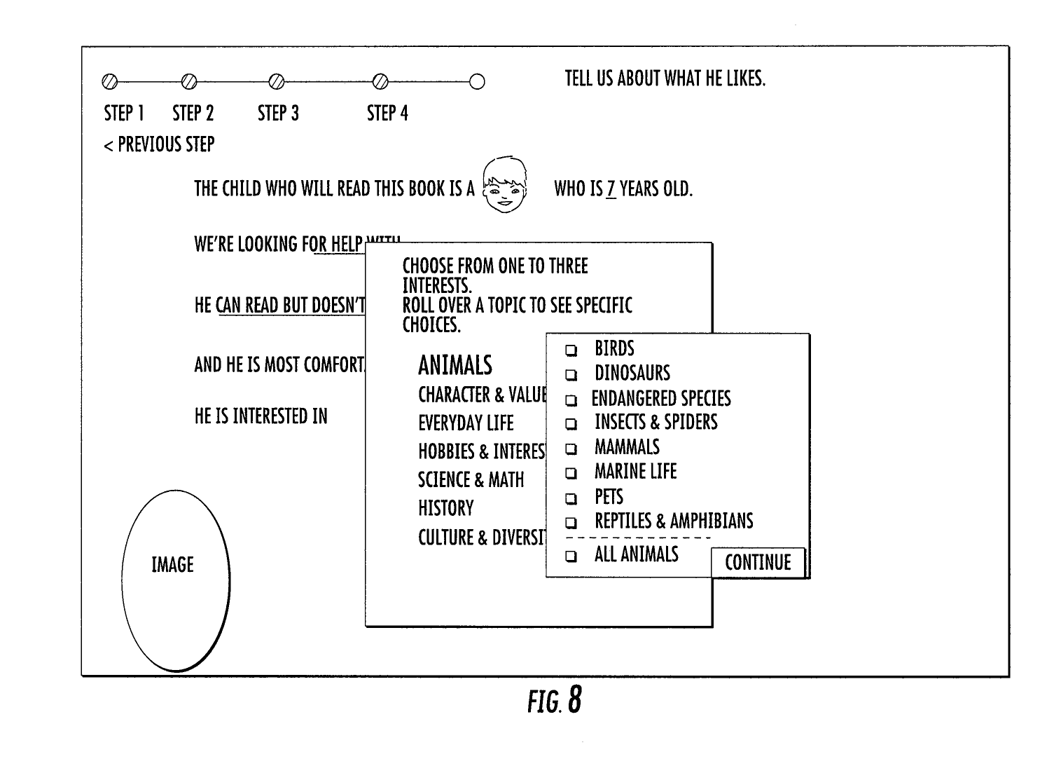

In step 460, the system can set the reader's reading level in reader table 246 and then seeks subject matter(s) that the reader would prefer. FIGS. 7 and 8 are screen diagrams illustrating selecting subject matter of interest to a reader in a preferred embodiment. As illustrated in FIGS. 7 and 8, the user is guided through a series of hierarchical Web pages to choose topics for the reader. The system can process the topics into corresponding subject matter classifications and add them to the reader table 246.

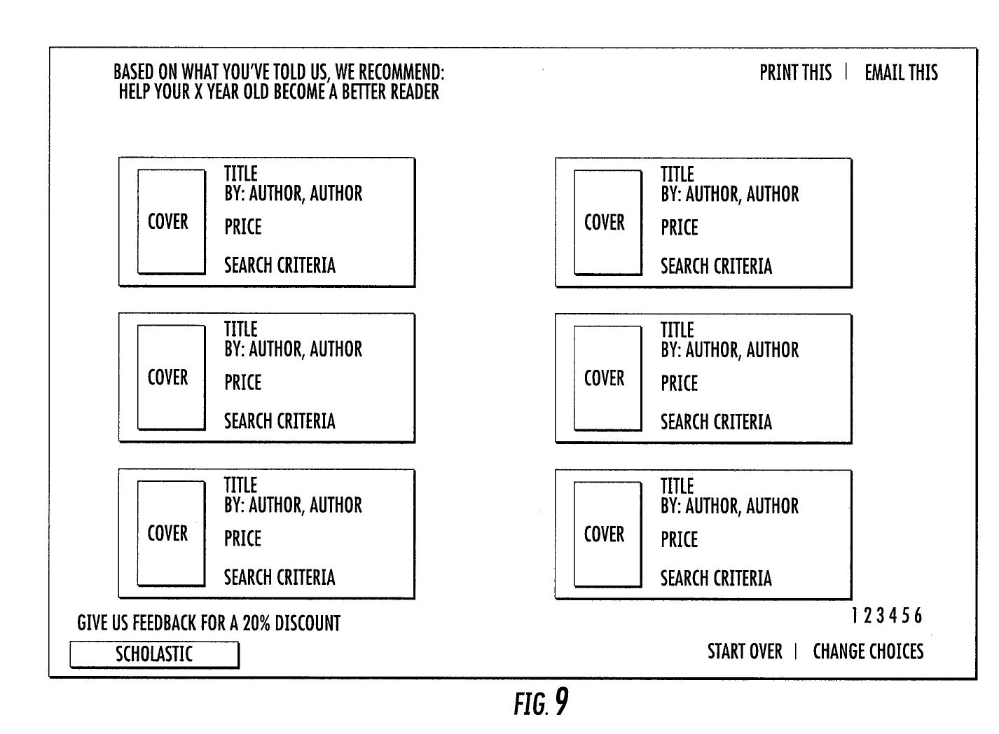

Returning to FIG. 4, in step 470, the system recommends books to the user for the reader. The system performs this task by issuing a database procedure to query book table 242 for books that match the classifications and reading level of the reader, found in reader table 246. FIG. 9 is a screen diagram that represents book recommendations presented to the user.

In an alternate preferred embodiment, the age or grade level is not presented on the screen, so that the reader does not feel embarrassed about reading at a level below what is expected, or so that the reader does not inflate his or her own abilities.

Software on Media

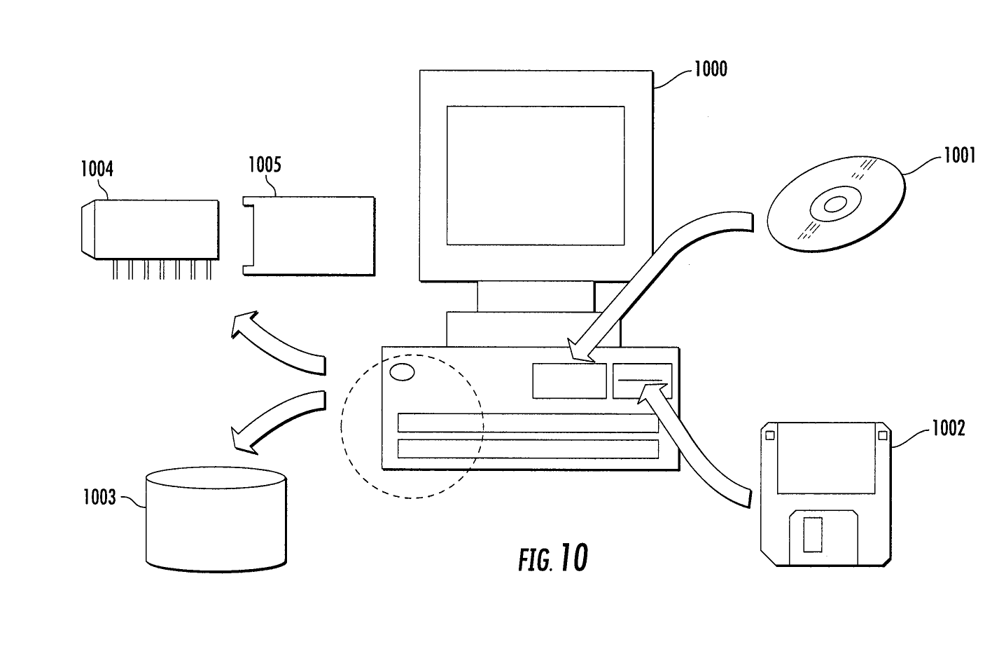

In the specification, the term “media” means any computer-readable medium that can record data therein. FIG. 10 illustrates examples of recordable computer-readable media.

The term “media” includes, for instance, a disk shaped media for 1001 such as CD-ROM (compact disc-read only memory), magneto optical disc or MO, digital video disc-read only memory or DVD-ROM, digital video disc-random access memory or DVD-RAM, a floppy disc 1002, a memory chip 1004 such as random access memory or RAM, read only memory or ROM, erasable programmable read only memory or E-PROM, electrical erasable programmable read only memory or EE-PROM, a rewriteable card-type read only memory 1005 such as a smart card, a magnetic tape, a hard disc 1003, and any other suitable means for storing a program therein.

A recording media storing a program for accomplishing the above mentioned apparatus maybe accomplished by programming functions of the above mentioned apparatuses with a programming language readable by a computer 1000 or processor, and recording the program on a media such as mentioned above.

A server equipped with a hard disk drive may be employed as a recording media. It is also possible to accomplish the present invention by storing the above mentioned computer program on such a hard disk in a server and reading the computer program by other computers through a network.

As a computer 1000, any suitable device for performing computations in accordance with a computer program may be used. Examples of such devices include a personal computer, a laptop computer, a microprocessor, a programmable logic device, or an application specific integrated circuit.

Having thus described at least illustrative embodiments of the invention, various modifications and improvements will readily occur to those skilled in the art and are intended to be within the scope of the invention. Accordingly, the foregoing description is by way of example only and is not intended as limiting. The invention is limited only as defined in the following claims and the equivalents thereto.

What is claimed is:

1. A method of determining a reading level of a reader, comprising:
presenting a passage correlated with an estimated reading level;
soliciting feedback that indicates relative ability of the reader to read the passage; and
determining the reading level of the reader from the feedback.

2. The method of claim 1, further comprising determining the estimated reading level from information about the reader.

3. The method of claim 2, wherein the information comprises age.

4. The method of claim 2, wherein the information comprises grade level.

5. The method of claim 1, wherein the reading level comprises a lexile measure.

6. The method of claim 1, further comprising:
presenting one or more additional passages in response to the feedback, each of the additional passages having a different estimated reading level;
receiving feedback that indicates a particular passage is commensurate with reading ability of the reader; and
setting the reading level of the reader at reading level of the particular passage.

7. The method of claim 1, further comprising:
if the feedback indicates that presented passage is above the reader's relative ability to read the presented passage then presenting an additional passage with a lower estimated reading level; or
if the feedback indicates that presented passage is below the reader's relative ability to read the presented passage then presenting the additional passage with a higher estimated reading level.

8. A method of recommending a book to a reader, comprising:
presenting a passage correlated with an estimated reading level;
soliciting feedback that indicates relative ability of the reader to read the passage;
determining the reading level of the reader from the feedback; and
recommending one or more books associated with the determined reading level.

9. The method of claim 8, further comprising:
presenting one or more additional passages in response to the feedback, each of the additional passages having a different estimated reading level;
receiving feedback that indicates a particular passage is commensurate with reading ability of the reader; and
setting the reading level of the reader at reading level of the particular passage.

10. The method of claim 8, wherein the reading level comprises a lexile measure.

11. The method of claim 8, further comprising:
soliciting information to determine the estimated reading level of the reader; and
selecting the passage having a reading level around the estimated reading level.

12. The method of claim 11, wherein the information comprises an age of the reader.

13. The method of claim 11, wherein the information comprises a grade level of the reader.

14. The method of claim 8, further comprising receiving information concerning subject matter classification.

15. The method of claim 14, wherein recommending further comprises selecting books associated with the information received concerning subject matter classification.

16. A computer system to determine a reading level of a reader, comprising:
a processor;
a memory;
a display;
a user interface; and
software stored on a computer-readable medium which, when loaded and run by the processor, causes the processor to perform steps of:
presenting a passage correlated with an estimated reading level of the reader;
soliciting feedback that indicates relative ability of the reader to read the passage; and
determining the reading level of the reader from the feedback.

17. The computer system of claim 16, wherein the software causes the processor to perform additional steps of:
soliciting age or grade level information about the reader;
determining the estimated reading level of the reader from the information; and
selecting the passage having a reading level around the estimated reading level.

18. The computer system of claim 17, wherein the software causes the processor to perform additional steps of:
presenting one or more additional passages in response to the feedback, each of the additional passages having a different estimated reading level;
receiving feedback that indicates a particular passage is commensurate with reading ability of the reader; and
setting the reading level of the reader at reading level of the particular passage.

19. The computer system of claim 18, wherein the software causes the processor to perform an additional step of recommending one or more books associated with the determined reading level.
